(19) United States
(12) Patent Application Publication
(10) Pub. No.: US 2021/0015090 A1
(43) Pub. Date: Jan. 21, 2021

(54) BAIT STATION AND INSERT

(71) Applicant: Matthew Ryan Galloway, Effingham, IL (US)

(72) Inventor: Matthew Ryan Galloway, Effingham, IL (US)

(73) Assignee: Liphatech, Inc., Milwaukee, WI (US)

(21) Appl. No.: 16/514,719

(22) Filed: Jul. 17, 2019

(51) Int. Cl. A01M 25/00

(52) U.S. Cl. CPC A01M 25/002

(57) ABSTRACT

A bait station and an associated insert are provided. The bait station includes a housing that incorporates a floor member with a plurality of openings in the same that allow pieces of bait and other debris to fall through the openings of the floor member. The insert includes a tray and the floor member which together may be inserted as a unit into the housing of the bait station.

### FIELD OF THE INVENTION

This invention generally relates to pest control products, and more particularly to reusable bait stations used for pest control applications.

### BACKGROUND OF THE INVENTION

Bait stations are used in a variety of environments for pest control. As their name implies, they contain bait which attracts a target animal (also referred to as a pest), or a class of target animals. The bait contains powerful active ingredients used to kill the pest that ingests the bait. In the case of rodents, for example, the bait is a rodenticide. The bait station can be generally described as a housing that encloses an interior space which contains the bait. The housing has one or more entry points that allow the pest to enter the device and ingest the bait. Once ingested, the pest typically leaves the bait station and dies some time thereafter.

The housings typically include provisions for holding the bait in place. For example, preformed blocks of rodenticide or soft bait rodenticide, etc. may be situated on rods or the like within the interior space of the housing. This keeps the bait readily accessible to the pest. Such bait stations may come in a variety of sizes, have a variety of cosmetic designs, and allow for the use of multiple pieces of bait at once.

While such bait stations have proven to be an effective means for pest control, they are not without some drawbacks. For example, as mentioned above the bait contains powerful active ingredients which may be harmful to other animals. As also mentioned above, the pests do not typically die within the bait station after ingesting the bait. Rather, the pests typically leave the bait station and die elsewhere. The bait itself tends to crumble and flake when gnawed on or eaten by the pest. Some of these crumbles or flakes may become temporarily caught in the pest's fur. Further, the same crumbles or flakes may also fall on the floor of the bait station and subsequently become temporarily entrapped in the pest's feet or paws.

Whether caught in the pest's fur or feet or paws, these uneaten pieces of bait are carried out of the bait station and then broadcast to surrounding areas when they fall off of the pest. In large enough amounts, these uneaten pieces of bait can harm other non-target animals. This is particularly problematic for free range farms. For non-limiting example, free range chickens or free range swine may confuse the pieces of uneaten bait on the ground as feed stuffs and consume the same.

Heretofore, the only option to minimize the risk of the bait being eaten by non-target animals is to forego the use of bait stations entirely, in favor of other devices such as mechanical traps or the like. Such mechanical traps or the like, however, are not as effective as the bait stations themselves as they are more costly, require frequent removal of trapped pests, and can be harmful to humans, depending on the size of the trap.

Accordingly, there is a need in the art for a bait station that reduces or entirely eliminates any unintended broadcasting of bait outside of the housing of the bait station. The invention provides such a bait station. These and other advantages of the invention, as well as additional inventive features, will be apparent from the description of the invention provided herein.

### BRIEF SUMMARY OF THE INVENTION

In one aspect, the invention provides bait station for containing bait. An embodiment of such a bait station includes a housing enclosing an interior space and defining at least one opening permitting access to the interior space from an exterior of the housing. This embodiment also includes a floor member situated within the interior space and elevated above a bottom wall of the housing. The floor member includes a plurality of openings configured to allow pieces of said bait to pass through said openings such that the pieces of said bait are contained within a containment space below the floor member and above the bottom wall of the housing.

In an embodiment according to this aspect, the plurality of openings are formed between a plurality of slats of the floor member. The floor member can include one or more supports extending outwardly from said floor member.

In embodiment according to this aspect, the floor member includes a base portion, an extension portion, and an upright portion. The upright portion of the floor member extends generally perpendicular to the base portion of the floor member. The extension portion of the floor member extends generally parallel to the base portion of the floor member. The extension portion includes at least one passage configured to allow a bait rod to extend through the at least one passage.

In an embodiment according to this aspect, the bait station also includes a tray interposed between the floor member and the bottom wall. The tray and floor member are snap-fit together such that the tray and floor member are removable as a unit from the bait station.

In an embodiment according to this aspect, the tray includes a base portion, an extension portion, and an upright portion. The upright portion of the tray extends generally perpendicular to the base portion of the tray. The extension portion of the tray extends generally parallel to the base portion of the tray. The extension portion of the tray includes at least one passage configured to allow a bait rod to extend through the at least one passage.

In another aspect, the invention provides a bait station for containing bait. An embodiment of such a bait station includes a housing enclosing an interior space and defining at least one opening permitting access to the interior space from an exterior of the housing. This embodiment also includes an insert that is removable from the housing. The insert includes a tray and a floor member spaced from the tray such that a containment space is provided between the floor member and the tray.

In an embodiment according to this aspect, the housing includes a lid connected via at least one hinge to a body of the housing that is movable between an open position and closed position. In an embodiment according to this aspect, the housing includes at least one lock configured to lock the lid in the closed position. In an embodiment according to this aspect, the at least one opening is sized to allow passage of an adult rodent into the interior space.

In yet another aspect, the invention provides an insert for a bait station for containing bait. The bait station includes a housing that encloses an interior space and provides at least one opening permitting access to the interior space from an exterior of the housing. The insert includes a tray and a floor member spaced from the tray such that a containment space is provided between the floor member and the tray. The tray and floor member are configured such that they are removable as a unit from the interior space of the housing.

In an embodiment according to this aspect, the floor member includes a plurality of openings configured to allow pieces of said bait to pass through said openings such that the pieces of said bait are contained within the containment space below the floor member and above the bottom wall of the housing. The plurality of openings are formed between a plurality of slats of the floor member. The floor member includes one or more supports extending outwardly from said floor member. The supports are L-shaped.

In an embodiment according to this aspect, the floor member includes a base portion, an extension portion, and an upright portion. The upright portion of the floor member extends generally perpendicular to the base portion of the floor member. The extension portion extends generally parallel to the base portion of the floor member.

In an embodiment according to this aspect, the tray includes a base portion, an extension portion, and an upright portion. The upright portion of the tray extends generally perpendicular to the base portion of the tray. The extension portion of the tray extends generally parallel to the base portion of the tray.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an exemplary embodiment of a bait station constructed in accordance with the teachings herein, with a lid of the bait station in the closed position;

FIG. 2 is a perspective view of the embodiment of FIG. 1, with the lid in the open position;

FIG. 3 is a perspective exploded view of the embodiment of FIG. 1;

FIG. 4 is a perspective view of an insert of the bait station of FIG. 1;

FIG. 5 is a perspective view of a tray of the insert of FIG. 4;

FIG. 6 is a perspective view of a floor member of the insert of FIG. 4; and

FIG. 7 is a perspective cross section of the insert of FIG. 4.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

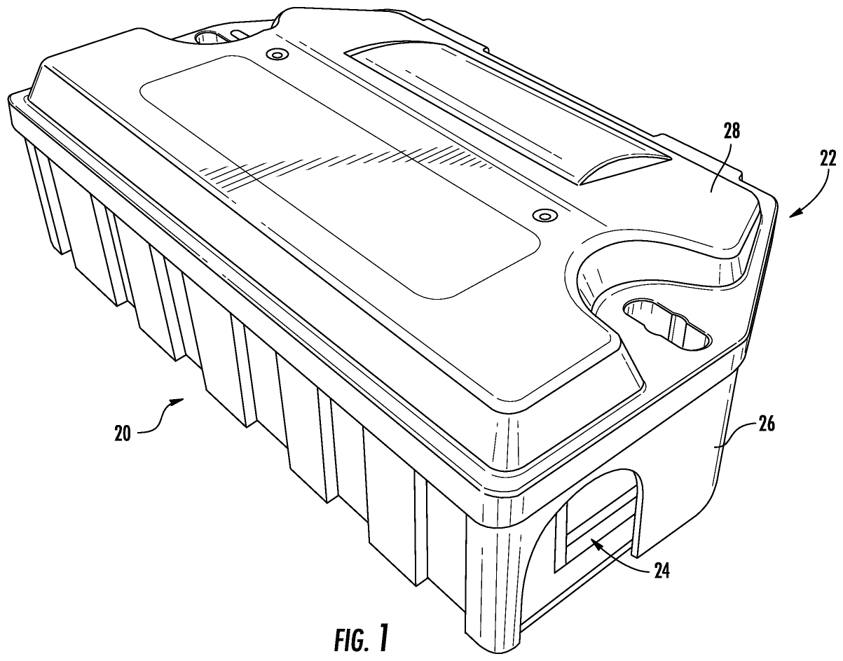

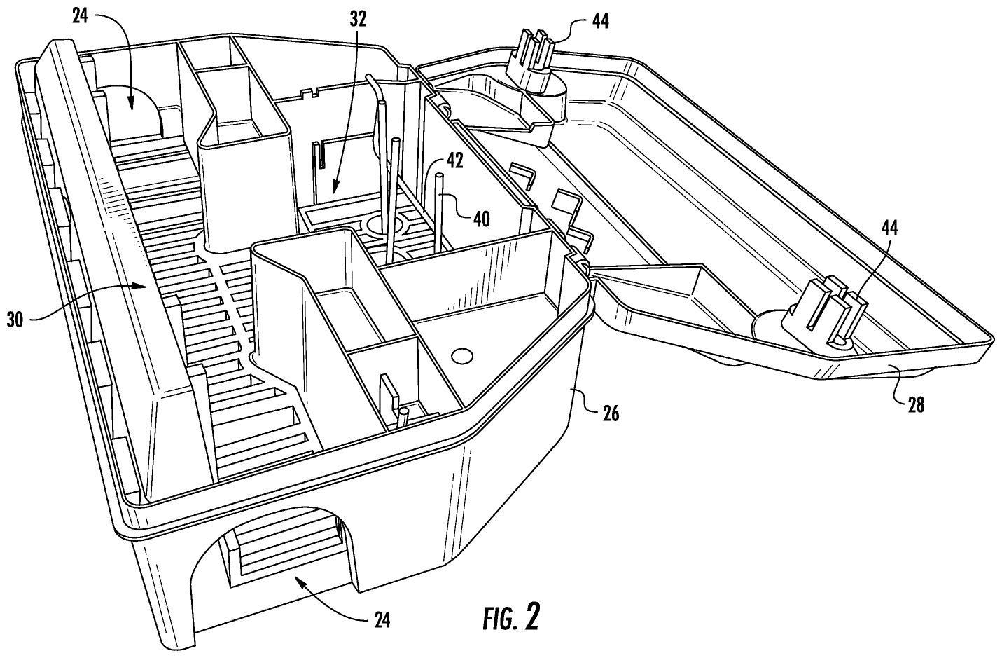

Turning now to the drawings, an exemplary embodiment of a bait station 20 and an insert 30 for such a bait station constructed in accordance with the teachings of the invention are illustrated. FIG. 1 is a perspective view of bait station 20. As may be seen in this view, bait station 20 includes a housing 22. Housing 22 includes a body 26 and a lid 28 which together enclose an interior space 32 (see FIG. 2) of bait station 20. One or more openings 24 are arranged to provide access to this interior space by a target animal. While the particular bait station 20 illustrated is ideal for rodents such as rats, mice, etc., it will be recognized from the teachings herein that bait station 20 may be configured for a variety of target animals by manipulating its shape and size. Accordingly, the particular bait station 20 illustrated, including its shape and its size, should be taken by way of example only, and the invention is not limited to any particular animal-specific bait station.

In FIG. 1, lid 28 is in its closed position wherein access to the interior space of bait station 20 is only possible via entry point 24. As described below, housing 22 may incorporate a lock for locking lid 28 in this closed position. Turning now to FIG. 2, bait station 20 is illustrated with lid 28 in its open position. In this position, interior space 32 is readily accessible through the top of body 26. In this configuration, bait (not illustrated) may be loaded onto one or more posts 40 or bar 42. Also illustrated in FIG. 2 are a pair of locks 44 used to achieve the above introduced locking functionality. Locks 44 may take on any form for locking lid 28 to body 26. A key may be utilized to unlock lid 28 from body 26.

Insert 30 is situated in interior space 32 as shown. As may be derived from inspection of FIG. 2, insert 30 assumes the general form of the interior space 32 so as to minimize movement of insert 30 in interior space 32. Insert 32 is aligned with openings 24 such that the target animal(s) may enter from either side of body 26 to reach posts 40 and bar 42 carrying the bait. Insert 30 is removable as a unit from interior space 32 by lifting the same out by hand. As explained below, such a configuration is advantageous as it allows for disposal of uneaten pieces of bait that are captured by insert 30.

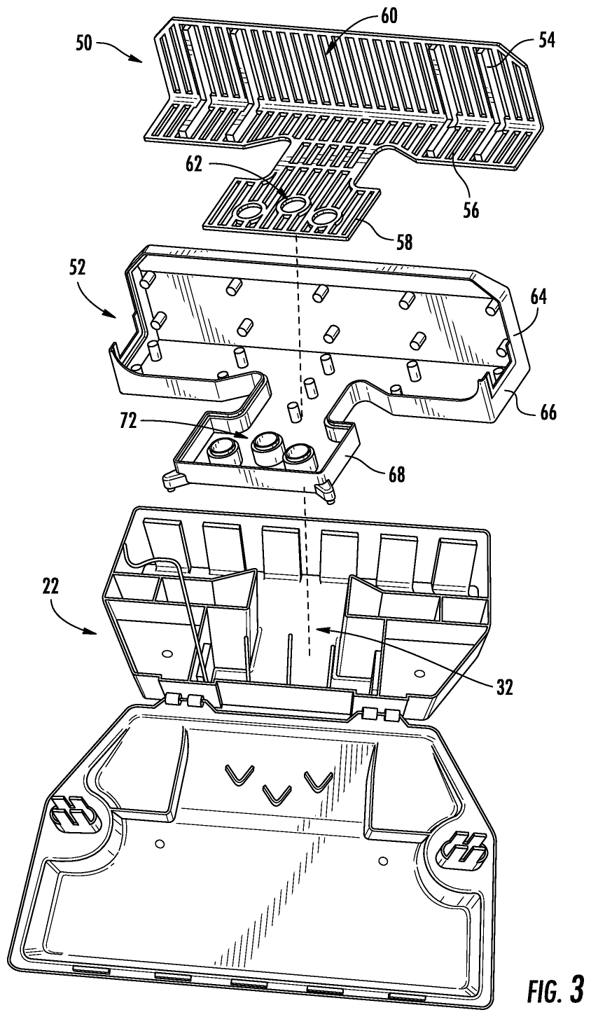

Turning now to FIG. 3, the same illustrates bait station 20 in an exploded view. Insert 30 includes a floor member 50 and a tray 52. Floor member 50 and tray 52 are assembled in such a way so as to elevate floor member 52 above a bottom wall of housing 22 defining the bottom of interior space 32. Likewise, floor member 50 and tray 52 are assembled in such a way so as to elevate floor member 50 above a bottom of tray 52. In either case, floor member 50 is positioned such that a containment space exists below floor member 50 and above the bottom wall of body 26 of housing 22. This containment space is used to contain uneaten pieces of bait which fall off the pieces of bait positioned on posts 40 and bar 42 (see FIG. 2). This reduces the risk that such uneaten pieces will be carried by a target animal outside of bait station 20.

Floor member 50 includes a plurality of openings 60 formed between adjacent slats of floor member 50 as shown. It is these openings which permit passage of the aforementioned uneaten pieces of bait. While shown as generally rectangular in shape due to the shape and arrangement of the slats, openings 60 may take on any other suitable form, such as for non-limiting examples circular perforations, etc. Indeed, any shape is sufficient which on the one hand will not inhibit the target-animal's ingress and egress from bait station 20, while on the other hand will allow for passage of the uneaten pieces of bait.

Floor member 50 also includes an upright portion 54, a base portion 56, and an extension portion 58. Upright portion 54 is generally perpendicular to base portion 56, and extension portion 58 is generally parallel to base portion 56. Similarly, tray 52 includes an upright portion 64, a base portion 66, and an extension portion 68. Upright portion 64 is generally perpendicular to base portion 66, and extension portion 68 is generally parallel to base portion 66. Further, each of floor member 50 and tray 52 include one or more passages 62, 72, respectively, which allow for passage of posts 40 vertically through insert 30 to elevate bait above floor member 50.

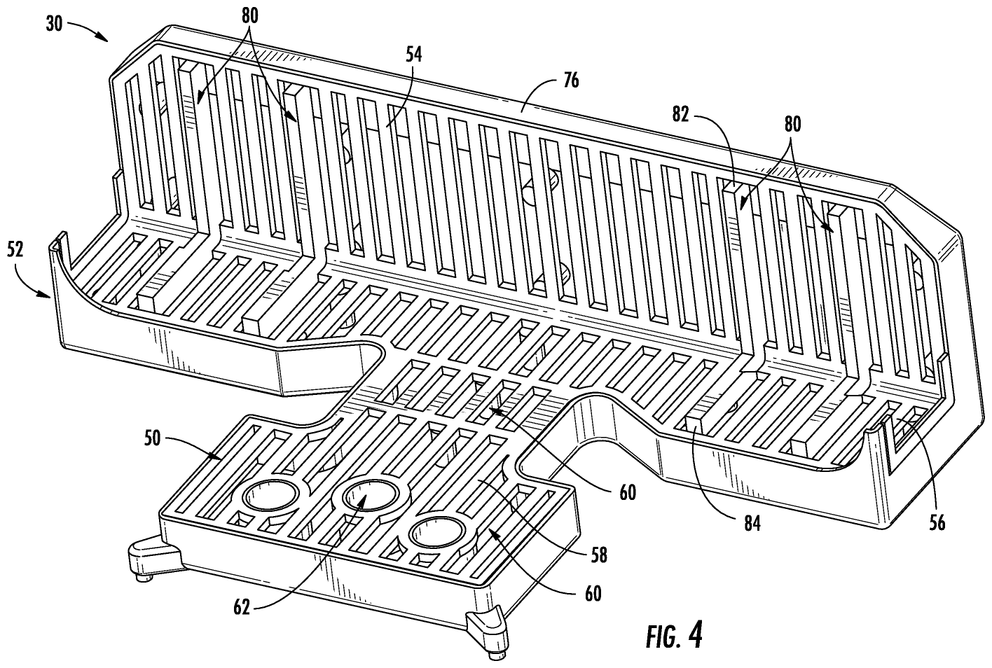

Turning now to FIG. 4, the same illustrates insert 30 removed from housing 22. As illustrated, insert 30 generally forms a right angle. However, insert 30 may take on any suitable shape and construction so as to capture uneaten bait which falls under gravity through openings 60.

In the illustrated embodiment, openings 60 are arranged such that they will be below and on the side of the target animal when the target animal is situated on floor member 50. This configuration not only serves to capture uneaten pieces of bait falling directly below the target animal, but also those pieces which may be trapped on the target animal's body. For example, as the target animal travels along base portion 54 to leave housing 22, it will rub against upright portion 54, and uneaten pieces of bait will also pass through the openings 60 in this region.

Still referring to FIG. 4, floor member 50 may also include a plurality of L-shaped supports 80 which structurally support floor member 50. Each support 80 includes its own upright portion 82 extending from upright portion 54, and a base portion 84 extending from base portion 56. Each support 80 also provides an additional surface or obstruction which the target animal will encounter when exiting housing 22, increasing the chances that additional uneaten pieces of bait on the body of the target animal will be removed thereby providing a combing function

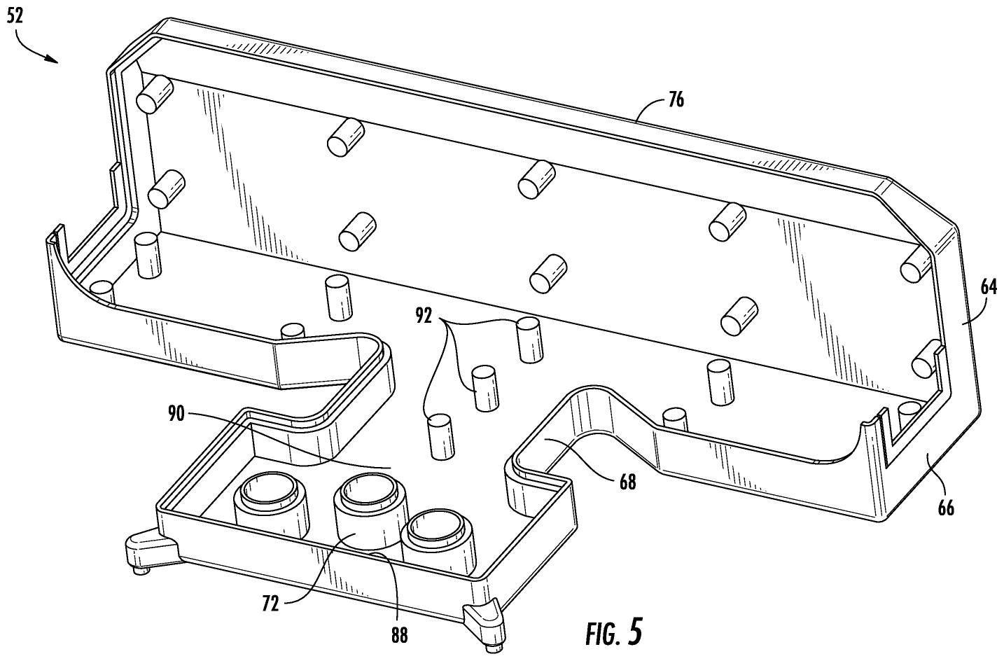

Turning now to FIG. 5, the same illustrates a perspective view of tray 52. As can be seen in this view, a rim 76 extends around the periphery of tray 52. A ledge 88 is situated adjacent this rim 76. Ledge 88 is used to support floor member 50 in its elevated position relative to tray 52. Additionally, a plurality of supports 92 may also be provided which support floor member 50 in a similar manner as ledge 88. As may be appreciated from FIG. 5, rim 76 effectively provides a barrier wall for containment of uneaten pieces of bait so that the same are contained within tray 52.

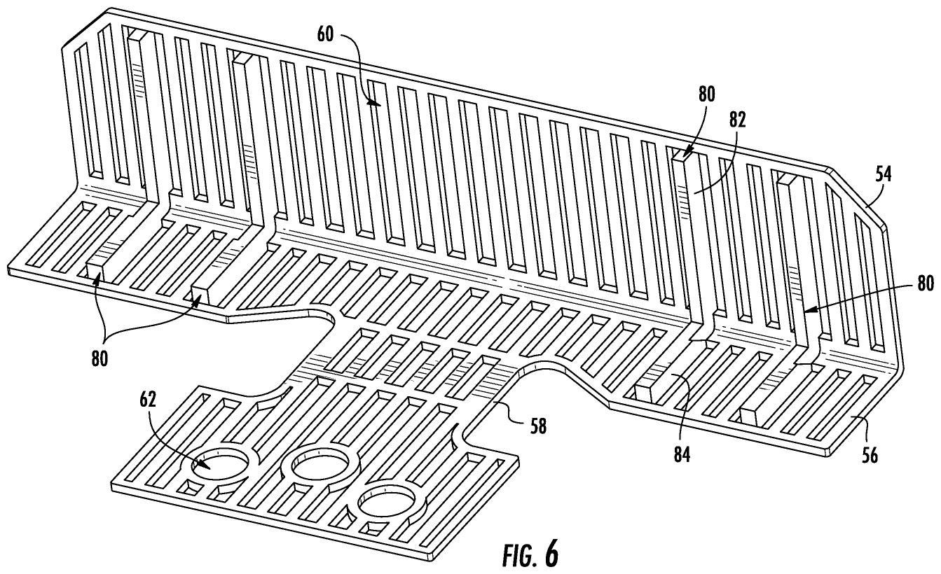

Floor member 50 is illustrated in FIG. 6. Floor member 50 is generally flat in the underside region of base portion 56 and extension portion 58 so that it may readily be supported by ledge 88 and supports 92. In an alternative configuration, supports 92 may be formed directly upon the underside of floor member 50. Such an alternative arrangement of supports 92 includes one or more supports depending downwardly from the underside of floor member 50 instead of depending upwardly from tray 52 as illustrated.

With such an alternative configuration, and referring momentarily back to FIG. 2, only the floor member 50 with its integrated supports 92 would be inserted into interior space 32. Uneaten pieces of bait would still fall through openings 60 and be contained within the containment space introduced above. Put differently, the containment space would not also include tray 52 with such a configuration, but instead be formed directly below floor member 50 and above the bottom wall of housing 22.

As such, it is contemplated by the teachings herein that tray 52 is an optional component and need not be present to practice the invention. Rather, all that is required is a floor member such as floor member 50 having integrated supports 92 or any other provision which would elevate the same above the bottom wall of housing 22 to thereby bound and define a containment space for capturing uneaten pieces of bait. However, use of the tray 50 provides the additional advantage of being able to easily remove the entire insert 30 as a unit from interior space 32, separate floor member 50 from tray 52, and invert tray 52 to dump out and dispose of uneaten pieces of bait captured by tray 52. Without tray 52, the entirety of bait station 20 needs to be manipulated with or without floor member 50 situated therein to dispose of uneaten pieces of bait captured thereby.

Further, when embodied as an insert such as insert 30 as illustrated, the same may be integrated with existing bait stations already in place. Indeed, insert 30 may be manufactured so as to assume the peripheral space of an interior space of an existing bait station and then retrofit therein. Many contemporary bait stations include a lid providing access to their corresponding interior space, so it is only a matter of ensuring that insert 30 can be dropped in place within the interior space. Such a configuration allows a site, such as a large agricultural operation, to enjoy the advantages of the invention described herein, without the necessity of fully replacing their existing bait stations.

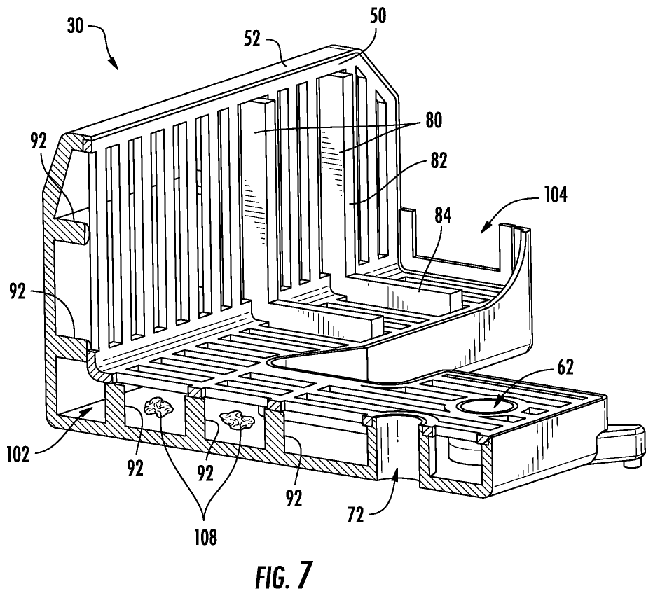

FIG. 7 illustrates insert 30 in cross section. As may be seen in this view, a portion of the above-introduced containment space 104 is illustrated between floor member 50 and tray 52 (the remainder of this containment space being that which the tray occupies when situated within housing 22). As also shown in this view, uneaten pieces of bait 108 are shown contained within this portion 104 of the containment space. As may be surmised from this illustration, these uneaten pieces of bait 108 are captured and cannot be transferred by the target animal into the surrounding environment.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A bait station for containing bait, comprising:
a housing, the housing enclosing an interior space and defining at least one opening permitting access to the interior space from an exterior of the housing;
a floor member situated within the interior space, the floor member elevated above a bottom wall of the housing; and
wherein the floor member includes a plurality of openings configured to allow pieces of said bait to pass through said openings such that the pieces of said bait are contained within a containment space below the floor member and above the bottom wall of the housing.

2. The bait station of claim 1, wherein the plurality of openings are formed between a plurality of slats of the floor member.

3. The bait station of claim 2, wherein the floor member includes one or more supports extending outwardly from said floor member.

4. The bait station of claim 3, wherein the floor member includes a base portion, an extension portion, and an upright portion, the upright portion of the floor member extending generally perpendicular to the base portion of the floor member, the extension portion of the floor member extending generally parallel to the base portion of the floor member.

5. The bait station of claim 4, wherein the extension portion includes at least one passage, the at least one passage configured to allow a bait rod to extend through the at least one passage.

6. The bait station of claim 1, further comprising a tray interposed between the floor member and the bottom wall.

7. The bait station of claim 3, wherein the tray and floor member are snap-fit together, the tray and floor member removable as a unit from the bait station.

8. The bait station of claim 7, wherein the tray includes a base portion, an extension portion, and an upright portion, the upright portion of the tray extending generally perpendicular to the base portion of the tray, the extension portion of the tray extending generally parallel to the base portion of the tray.

9. The bait station of claim 8, wherein the extension portion of the tray includes at least one passage, the at least one passage configured to allow a bait rod to extend through the at least one passage.

10. A bait station for containing bait, comprising:
a housing, the housing enclosing an interior space and defining at least one opening permitting access to the interior space from an exterior of the housing;
an insert, the insert removable from the housing, the insert comprising:
a tray; and
a floor member spaced from the tray such that a containment space is provided between the floor member and the tray.

11. The bait station of claim 10, wherein the housing includes a lid connected via at least one hinge to a body of the housing, the lid movable between an open position and closed position.

12. The bait station of claim 10, wherein the housing includes at least one lock, the at least one lock configured to lock the lid in the closed position.

13. The bait station of claim 10, wherein the at least one opening is sized to allow passage of an adult rodent into the interior space.

14. An insert for a bait station, the bait station including a housing that encloses an interior space, the housing providing at least one opening permitting access to the interior space from an exterior of the housing, the bait station configured to contain bait, the insert comprising:
a tray;
a floor member spaced from the tray such that a containment space is provided between the floor member and the tray; and
wherein the tray and floor member are configured such that they are removable as a unit from the interior space of the housing.

15. The insert of claim 14, wherein the floor member includes a plurality of openings configured to allow pieces of said bait to pass through said openings such that the pieces of said bait are contained within the containment space below the floor member and above the bottom wall of the housing.

16. The insert of claim 15, wherein the plurality of openings are formed between a plurality of slats of the floor member.

17. The insert of claim 16, wherein the floor member includes one or more supports extending outwardly from said floor member.

18. The insert of claim 17, wherein the supports are L-shaped.

19. The insert of claim 14, wherein the floor member includes a base portion, an extension portion, and an upright portion, the upright portion of the floor member extending generally perpendicular to the base portion of the floor member, the extension portion extending generally parallel to the base portion of the floor member.

20. The insert of claim 19, wherein the tray includes a base portion, an extension portion, and an upright portion, the upright portion of the tray extending generally perpendicular to the base portion of the tray, the extension portion of the tray extending generally parallel to the base portion of the tray.
